(19) United States
(12) Patent Application Publication
(10) Pub. No.: US 2006/0089907 A1
(43) Pub. Date: Apr. 27, 2006

(54) Invoice verification process

(76) Inventors: Klaus Kohlmaier, Leimen (DE); Eduard Hess, Wiesloch (DE); Benjamin Klehr, Rastatt (DE)

Correspondence Address: KENYON & KENYON LLP, ONE BROADWAY, NEW YORK, NY, 10004, US

(21) Appl. No.: 11/026,026

(22) Filed: Jan. 3, 2005

Related U.S. Application Data
(60) Provisional application No. 60/621,339, filed on Oct. 22, 2004.

(51) Int. Cl. G06Q 40/00

(52) U.S. Cl. 705/40

(57) ABSTRACT

The present invention provides a system and method for automatically verifying an invoice or credit memorandum and generating a payment or crediting an account. Upon receipt of a paper invoice or credit memorandum, an electronic invoice or credit memorandum having identifiable content may be generated using, for example, optical character recognition (OCR) technology. The invoice or credit memorandum may be automatically verified by comparing content received in the invoice or credit memorandum to records that are maintained describing the transaction. For example, the invoice or credit memorandum may be linked to a purchase order to verify whether any discrepancies exist. Additionally, a check may be made to ensure that the invoice or credit memorandum is not a duplicate. After verification is complete, the invoice or credit memorandum may be processed by an accounts payable system to either pay an outstanding balance or recognize a credit.

### BACKGROUND

Companies that engage in commercial transactions often communicate to each other using various forms to negotiate terms of their transactions. An exemplary transaction may be between a purchaser and a supplier for the purchase of goods or services. The transaction may be initiated by the purchaser sending the supplier a purchase order setting forth information concerning the desired purchase such as the number of items that are requested, the price, and a requested delivery date. The supplier may then provide the goods or services requested in the purchase order.

Upon completion of the transaction, the supplier may send the purchaser an invoice for payment of the goods or services provided by the supplier. The invoice may reference the purchase order that was used to initiate the transaction. The invoice may also provide a description of the goods or services provided and the cost of those goods or services. Upon receipt of the invoice, the purchaser may verify that the invoice is for goods or services that were ordered, ensure that the invoice is not a duplicate and then pay the amount requested.

Many midsized or smaller companies send paper invoices requesting payment. The purchaser may have the information on the invoice manually entered into a database for record keeping and to trigger an accounts payable department to pay the invoice. However, manually entering the data and/or manually verifying that the invoice is valid may be a cumbersome process, especially when a purchaser processes many invoices. Purchasers would benefit from an automated process in which a paper invoice was processed in an automated fashion allowing routine invoices to be paid automatically.

At times, a purchaser overpays or is otherwise entitled to a credit. For example, a purchaser may pay an invoice although shipment was late or the goods that were provided were of poor quality. The supplier may provide the purchaser with a credit towards future purchases to compensate for the poor performance. The supplier may notify a purchaser of the credit in a credit memorandum. Like an invoice, a paper credit memorandum may be sent to the purchaser who ordinarily enters data manually into a database. Addition ally, verification may be needed prior to using the credit to offset future purchases. Benefits would be obtained from an automated process to verify credit memoranda.

### BRIEF DESCRIPTION OF THE DRAWINGS

FIG. 1 depicts an invoice verification data flow diagram according to one embodiment of the invention.

FIG. 2 illustrates an invoice verification process with manual verification data flow diagram according to one embodiment of the invention.

FIG. 3 shows a credit memorandum verification process with manual verification data flow diagram according to one embodiment of the invention.

FIG. 4 illustrates an invoice processing network according to one embodiment of the invention.

FIG. 5 illustrates an invoice processor according to one embodiment of the invention.

### DETAILED DESCRIPTION

The present invention provides a system and method for automatically verifying an invoice or credit memorandum and generating a payment or crediting an account. Upon receipt of a paper invoice or credit memorandum, an electronic invoice or credit memorandum having identifiable content may be generated using, for example, optical character recognition (OCR) technology. The invoice or credit memorandum may be automatically verified by comparing content received in the invoice or credit memorandum to records that are maintained describing the transaction. For example, the invoice or credit memorandum may be linked to a purchase order to verify whether any discrepancies exist. Additionally, a check may be made to ensure that the invoice or credit memorandum is not a duplicate. After verification is complete, the invoice or credit memorandum may be processed by an accounts payable system to either pay an outstanding balance or recognize a credit.

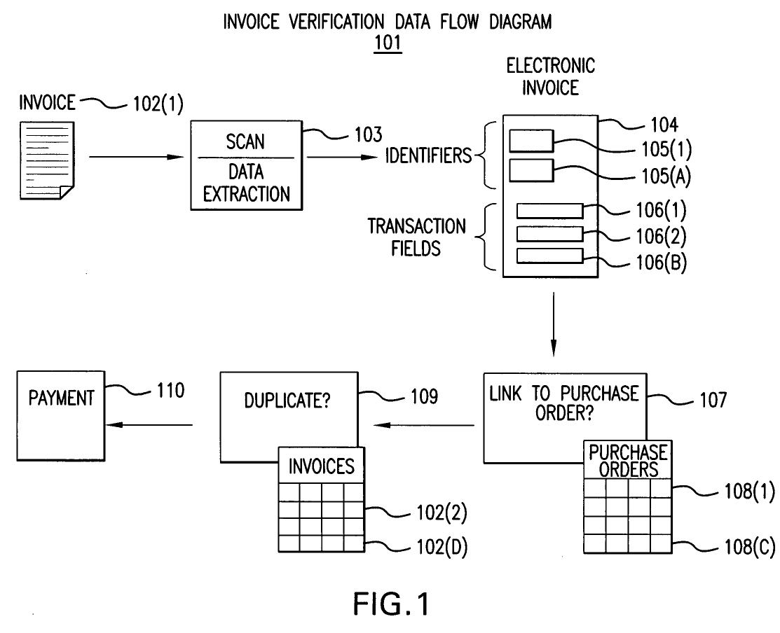

FIG. 1 depicts an invoice verification data flow diagram 101 according to one embodiment of the invention. Invoice verification provides an automated process for scanning an invoice 102 received via mail or facsimile (FAX) and extracting data from the invoice. The automated process generates an electronic invoice 104 and verifies that payment should be made by linking the invoice 102 to a purchase order 108 and checking for duplicates. When verification is complete, payment 110 is generated.

As illustrated by invoice verification data flow diagram 101, invoice verification is initiated by receipt of an invoice 102. The invoice 102 may be paper and received via any form of communication including mail, FAX, courier or as an attachment to an electronic form of communication, such as an electronic mail (e-mail) message. The invoice 102 may be any document that requests payment. In an alternate embodiment of the invention, invoice 102 is a credit memorandum that indicates payment or compensation for overpayment that will be provided by a supplier to a purchaser.

As reflected by step 103, the invoice 102 may be scanned and data may be extracted therefrom. Optical character recognition technology (OCR) may be used to covert invoice 102 to electronic invoice 104. Invoice 102 may be scanned or read by any OCR device including for example an optical scanner or FAX machine. Exemplary devices are those manufactured by Seeburger or Océ, but any OCR device may be used. The scanned content may be compared to various conditions that when present will trigger reading rules that will cause the scanned data to be recognized and tagged as a particular identifiable data element. For example, a character stream from the scanned document may be compared to “Invoice Serial No.” If the data matches, a string of characters of a preset length following that header may be extracted and identified as the serial number of the invoice 102. The data may be extracted into fields of an electronic form that are associated with field identifiers or tags so that they are can be distinguished and interpreted by computer program instructions. Credit memoranda may be converted to an electronic format in the same manner as invoice 102.

Different formats may be used to transmit an invoice 102 or a credit memorandum. Similar kinds of information may be placed in different spatial areas of the forms, possibly with different graphical clues including headers and boxes. When an invoice 102 or credit memorandum having a new format is received, the reading rules may be developed by training the system using definitions provided by an operator indicating which data is important and how that data should be recognized. The reading rule set can be stored so that it may be used to interpret future invoices from the same source.

Identifying data transmitted in the invoice 102 allows that data to be used to process the invoice 102. The data transmitted in the invoice 102 may comprise identifiers 105(1)-105(A), which may include any string of characters that identifies invoice 102 by naming or labeling invoice 102 or corresponding documents relating to the transaction(s) that generated invoice 102. Exemplary identifiers 105(1)-105(A) include invoice number or a purchase order number that initiated the transaction leading to the invoice 102. Invoice 102 may also include transaction fields 106(1)-106(B), which may store data describing the transaction including, for example, items or services purchased. Electronic invoice 104 that is generated from the invoice 102 may comprise identifiers 105(1)-105(A) and transaction fields 106(1)-106(B) as a result of content identification performed while converting the paper invoice 102 to an electronic format.

One or more of identifiers 105(1)-105(A) may be retrieved from electronic invoice 104 to link incoming invoice 102 to a purchase order 108, as reflected by step 107. Purchase order records 108(1)-108(C) may be stored for the purpose of maintaining a record describing the transaction that the parties initially agreed to. Linking invoice 102 to a purchase order 108 may be done to verify that the goods or services that were ordered were provided and that the terms of the purchase, such as the delivery date, were adhered to by the supplier. Once a purchase order 108 corresponding to invoice 102 is identified using one or more of identifiers 105(1)-105(A), verification may be done using transaction fields 106(1)-106(B).

After the purchase conditions are verified using purchase order 108, as indicated by step 109, a check may be done to determine if, for example, an newly received invoice 102(1) is a duplicate. Other invoices 102(2)-102(D) may be searched using one or more identifiers 105(1)-105(A) to locate duplicates, if any. An exemplary identifier that may be used is an invoice serial number.

If no duplicates are identified, payment may be generated as is reflected by step 110. Payment may be automatically generated by accounts payable systems. Payment may also be subject to manual verification or may be made manually. Payment may include any form of compensation agreed to by the purchaser and the supplier and need not include the transfer of money.

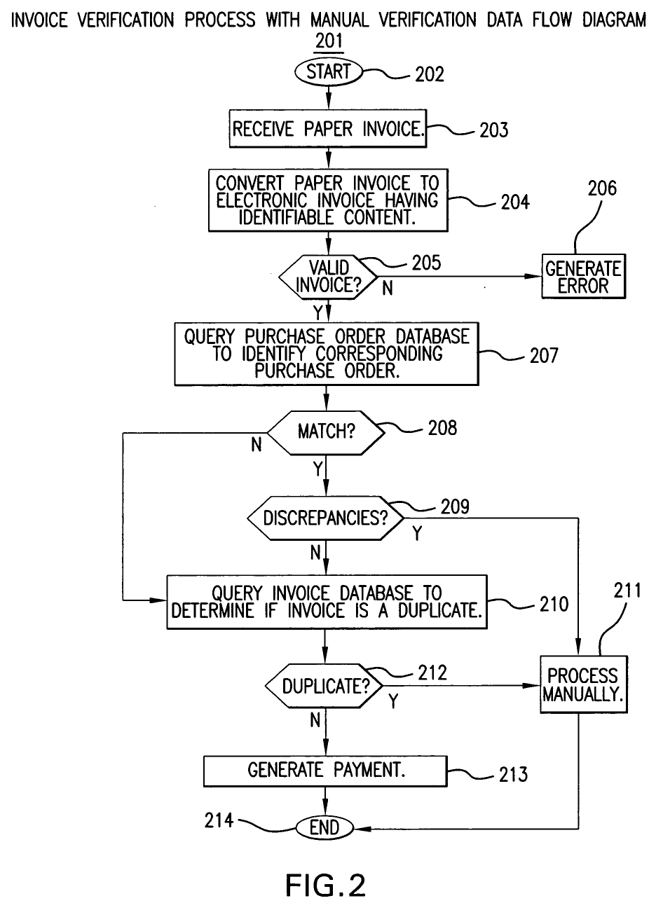

FIG. 2 illustrates an invoice verification process with manual verification data flow diagram 201 according to one embodiment of the invention. In step 203, a paper invoice 102 is received. The paper invoice 102 may be received via any form of communication, such as mail, FAX, courier or printed from an attachment of an e-mail.

In step 204, the paper invoice 102 is converted to an electronic format having identifiable content, using for example OCR technology. The resulting electronic invoice 104 may have any file format that is recognized by a programmable processor, such as Extensible Markup Language (XML) format. Electronic invoice 104 may comprise identifiable fields that can be used for processing. Identifiable fields may include elements of an electronic form that are recognized using an electronic convention for distinguishing one element of a form from another, such as tags or field identifiers. This allows data stored in fields of electronic invoice 104 to be easily located and retrieved.

In step 205, a determination is made of whether a valid electronic invoice 104 has been generated. Various errors may occur while converting invoice 102 to an electronic format. Additionally, invoice 102 may have been flawed when it was received. If electronic invoice 104 is not in a proper format, processing errors may occur and payment may be inaccurately made or denied. An electronic invoice 104 may be parsed to ensure that the identifiable fields comprise valid data. Valid formats may be stored for various fields of the invoice 102, including formats for invoice serial numbers, purchase order numbers, and other data transmitted by invoice 102. The identifiers 105(1)-105(A) and transaction fields 106(1)-106(B) may be compared to these valid formats. If there is a discrepancy, an error may be recognized. If an error is detected, an error message may be generated, as reflected by step 206, and processing of invoice 102 may be done manually.

In step 207, a query may be sent to a purchase order database storing purchase orders 108(1)-108(C) to identify a corresponding purchase order 108. A query may comprise any of identifiers 105(1)-105(A), such as a purchase order number included on invoice 102.

In step 208, a search may be performed in the purchase order database to locate a purchase order number that is the same as the purchase order number sent in the query. A determination may be made as to whether any of the purchase order numbers searched matches the purchase order number of invoice 102. If no match is located, automated processing may continue by proceeding to step 210 to identify duplicates, if any. A message may be generated alerting a purchase administrator that automated verification could not be performed because no corresponding purchase order was identified. In an alternate embodiment of the invention, no additional automated processing is performed if no match for a purchase order is located. Instead, the invoice 102 is processed manually.

If a matching purchase order number is located, step 209 is reached. A comparison of information provided in invoice 102 is made with information stored by purchase order 108. Data stored in transaction fields 106(1)-106(B), which describe the purchase, may be compared to data stored by purchase order records 108(1)-108(C) to find discrepancies, if any. For example, transaction fields 106(1)-106(B) may include a list of items or materials purchased, including a description of the items or materials as well as the quantity ordered. This information may be compared with a description and quantity of items or materials requested in purchase order 108. If a discrepancy is noted, the cost of the items or materials may be recalculated to ensure that the purchaser was not overcharged. For example, a purchase order may reflect that 100 Kg of iron casings were ordered but the invoice 102 may reflect that only 50 Kg of iron casings were delivered. If the cost is 30 U.S. Dollars for 50 Kg of iron casings, a recalculation may be done to ensure that the purchaser was charged only 30 U.S. Dollars and not 60 U.S. Dollars, as would be the cost if a full shipment had been made. If discrepancies are found, manual processing may be used as is reflected by step 211.

If no discrepancies are found, step 210 is reached. In step 210, a query is sent to an invoice database storing other invoices 102(2)-102(D) that were received previously. A comparison may be made using data stored in an identifier field 105(1)-105(A), such as an invoice serial number. This may be compared to invoice serial numbers of invoices 102(2)-102(D). If a match is found, a duplicate may have been located and manual processing is performed, as is reflected by step 211. If no duplicate is located, automated processing may continue.

In step 213, payment is generated. If invoice 102 is verified and is not a duplicate, payment may be automatically generated. For example, an accounts payable system may cause a check to be generated or a wire transfer to be made to a supplier's account. This allows a purchase administrator to focus on issues that arise during processing of invoices 102(1)-102(D) while routine payments are automatically processed. In an alternate embodiment of the invention, a payment may be automatically generated by notifying an administrator that payment is needed so that a manual payment can be executed. Any form of compensation to a supplier may constitute a payment.

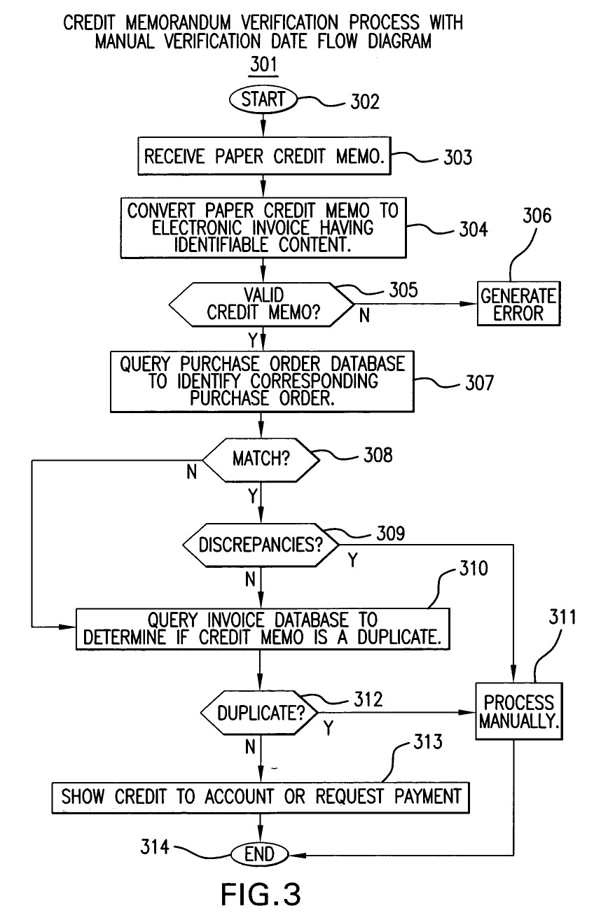

FIG. 3 illustrates a credit memorandum verification process with manual verification data flow diagram 301 according to one embodiment of the invention. In step 303, a paper credit memorandum is received. The paper credit memorandum may be received via any form of communication, such as mail, FAX, courier or printed from an attachment of an e-mail. The credit memorandum may be any form of communication that indicates that a supplier is providing payment or credit to the purchaser. The payment or credit may be any form of compensation and does not require a transfer of money.

In step 304, the paper credit memorandum is converted to an electronic format having identifiable content, using for example OCR technology. The resulting electronic credit memorandum may have any file format that is recognized by a programmable processor, such as Extensible Markup Language (XML) format. An electronic credit memorandum may comprise identifiable fields that can be used for processing. Identifiable fields may include elements of an electronic form that are recognized using an electronic convention for distinguishing one element of a form from another, such as tags or field identifiers. This allows data stored in fields of the electronic credit memorandum to be easily located and retrieved. Identifiable fields may include identifiers that may be any string of characters that that identifies the credit memorandum by naming or labeling the credit memorandum or corresponding documents relating to the transaction(s) that generated the credit memorandum.

In step 305, a determination is made of whether a valid credit memorandum has been received. Various errors may occur while converting a paper credit memorandum to an electronic format. Additionally, the credit memorandum may have been not been in a recognizable format, may have been missing data or may have been otherwise flawed when it was received. If the converted credit memorandum is not in a proper format, processing errors may occur and the credit or payment may not be accurately reflected by the purchaser's systems. An electronic credit memorandum may be parsed to ensure that the identifiable fields comprise valid data. For example, the format of various fields may be compared to valid formats stored by a database to identify any discrepancies. If a discrepancy is detected, an error message may be generated, as reflected by step 306, and processing of the credit memorandum may be done manually.

In step 307, a query may be sent to a purchase order database storing purchase orders 108(1)-108(C) to identify a corresponding purchase order 108 to verify that a credit is due and that the correct amount is being credited to the purchaser. For example, a purchaser may be receiving a credit because a supplier failed to ship goods or shipped faulty or substitute goods that were ordered using a purchase order form. A query may comprise one or more identifiers, such as a purchase order number extracted from the credit memorandum.

In step 308, a search may be performed in the purchase order database to locate a purchase order number that is the same as the purchase order number sent in the query. If no match is located, automated processing may continue by proceeding to step 310 to identify duplicates, if any. A message may be generated alerting a purchase administrator that no corresponding purchase order was identified. In an alternate embodiment of the invention, additional checks are performed depending on the type of credit memorandum received. For example, if a supplier is offering a bulk-rate discount based on a volume of purchases ordered using multiple purchase orders, a calculation may be performed using data stored in the purchase order database to ascertain the total number of items purchased from the supplier and ensure that an accurate credit is being provided. In another alternate embodiment of the invention, no additional automated processing is performed if no match for a purchase order is located. Instead, the credit memorandum is processed manually.

If a matching purchase order number is located, step 309 is reached. In step 309, data extracted from the credit memorandum is compared to information stored in the purchase order database to verify that the correct credit or payment was provided. For example, if a credit is provided for failure to ship goods, the quantity of goods for which credit was received may be compared to the quantity of goods ordered. If there is a discrepancy, an error may be noted and manual processing may be performed, as is reflected by step 311. Additionally, the cost of the items or materials may be calculated, for example, if a partial shipment is received, to ensure that the credit amount is correct. For example, a purchase order may reflect that 100 Kg of iron casings were ordered but the credit memorandum may reflect that only 50 Kg of iron casings were delivered. If the cost is 30 U.S. Dollars for 50 Kg of iron casings, calculation may be done to ensure that purchaser was credited 30 U.S. Dollars. If discrepancies are found, manual processing may be used as is reflected by step 311.

If no discrepancies are found, step 310 is reached. In step 310, a query is sent to a database storing other credit memoranda that were received previously. Identifiers extracted from the credit memorandum may be compared to serial numbers of other credit memoranda. If a match is found, a duplicate may have been located. Step 311 is reach and manual processing is performed. If no duplicate is located, automated processing may continue.

In step 313, the credit or payment is reflected in purchaser's accounting system. Automatic processing of a credit or payment may be done by showing a credit on supplier's account that may be used towards future purchases. Alternatively, money may be deposited in purchaser's account. This allows a purchase administrator to focus on issues that arise during processing of credits while routine credits and payments are automatically processed.

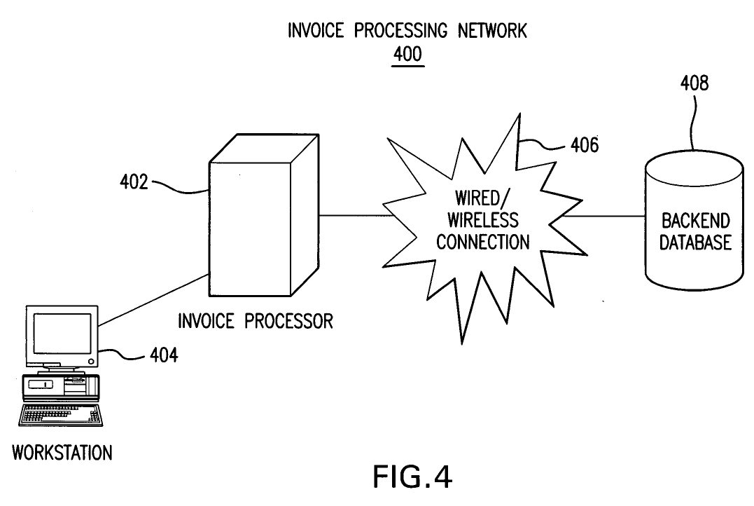

FIG. 4 illustrates an invoice processing network 400 according to one embodiment of the invention. Invoice processing network 400 may comprise an invoice processor 402 that processes incoming invoices 102(1)-102(D) and generates a payment. In an alternate embodiment of the invention, invoice processor 402 processes credit memoranda and acknowledges a credit or accepts a payment.

Invoice processor 402 may be connected to workstation 404 so that an administrator may view a graphical user interface providing information about duplicates or discrepancies that are identified during invoice or credit memorandum verification. Invoice processor 402 may also be connected to backend database 408 via wired/wireless connection 406. Any of purchase order database, invoice database, valid format database or any other data used for invoice processing may be stored locally on invoice processor 402 or on backend database 408.

Workstation 404 may be used to view user interfaces providing information to make decisions regarding verification of invoices 102(1)-102(D) or credit memoranda. Workstation 404 may be any programmable processor connected to a machine-readable medium that can provide a user interface such as a computer having a graphical user interface (GUI), a phone, or a personal data assistant. Such devices may comprise an output device that can provide to a user any form of sensory feedback such as voice, auditory or tactile (e.g., liquid crystal display (LCD), cathode ray tube (CRT), or earpiece) and an input device providing any form of input to the computer including acoustic, speech, or tactile input (e.g., keyboard, mouse, trackball, keypad).

Backend database 408 may be any data stored on any machine-readable medium including any computer program product, apparatus and/or device (e.g., a random access memory (RAM), read only memory (ROM), magnetic disk, optical disk, programmable logic device (PLD), tape or any combination of these devices). Backend database 408 may be stored according to any file format that may be used to organize data, including HTML file format.

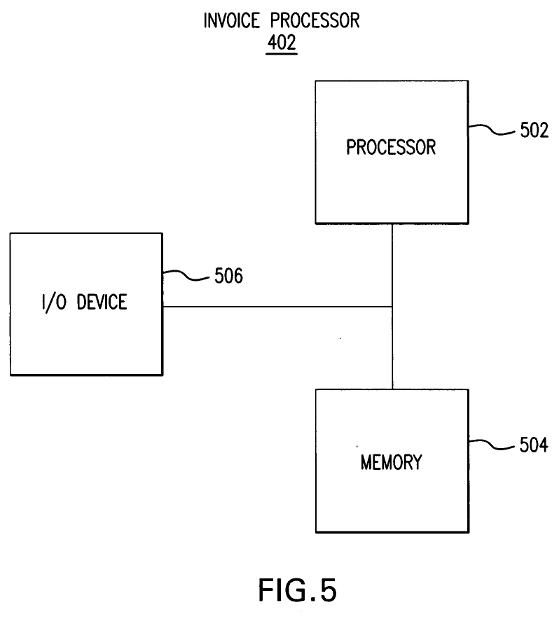

FIG. 5 illustrates an invoice processor 402 according to one embodiment of the invention. Invoice processor 402 includes processor 502, memory 504, and I/O device 506. Processor 502 is connected to memory 504. Processor 502 is also connected to I/O device 506. These connections are direct or via other internal electronic circuitry or components.

Processor 502 may be any programmable processor that executes instructions residing in memory 504 to receive and send data via I/O device 506 including any programmable microprocessor or combination of microprocessors or processors that can operate on digital data, which may be special or general purpose processors coupled to receive data and instructions from, and to transmit data and instructions to, a machine-readable medium. According to one embodiment of the present invention processor 502 is an Intel microprocessor.

Memory 504 may be any machine-readable medium that stores data that is processed by processor 502 including any computer program product, apparatus and/or device (e.g., a random access memory (RAM), read only memory (ROM), magnetic disc, optical disc, programmable logic device (PLD), tape, or any combination of these devices). This may include external machine-readable mediums that are connected to processor 502 via I/O device 506. I/O device 506 may be any coupling that can be used to receive and/or send digital data to and from an external device.

Various implementations of the systems and techniques described here can be realized in any processing systems and/or digital electronic circuitry, integrated circuitry, specially designed ASICs (application specific integrated circuits), computer hardware, firmware, software, and/or combinations thereof.

A number of embodiments of the invention have been described. Nevertheless, it will be understood that various modifications may be made without departing from the spirit and scope of the invention.

What is claimed is:

1. An invoice processing method comprising:
converting a paper invoice to an electronic format;
extracting data from the electronic format based on rules associated with a source of the invoice;
comparing invoice identification data extracted from the invoice to a data set storing valid invoice identifiers; and
unless the comparison indicates that the received invoice is a duplicate of another previously received invoice, passing the extracted data to a payment system.

2. An invoice processing method comprising:
converting a paper invoice to an electronic format;
extracting data from the electronic invoice based on rules associated with a source of the invoice;
comparing invoice identification data extracted from the invoice to a data set storing valid invoice identifiers;
comparing transaction data extracted from the invoice to a second data set of purchase order records to identify discrepancies, if any; and
unless the first comparison indicates that the received invoice is a duplicate of another previously received invoice or the second comparison indicates discrepancies between the transaction data extracted from the invoice and the purchase order records, passing the extracted data to a payment system.

3. The invoice processing method of claim 2 further comprising comparing extracted data to valid field formats to verify that the invoice is valid.

4. The invoice processing method of claim 2 wherein the conversion of the paper invoice is done using optical character recognition technology.

5. The invoice processing method of claim 2 wherein the transaction data extracted from the invoice comprises a quantity of goods purchased and a description of the goods purchased.

6. A credit memorandum processing method comprising:
converting a paper credit memorandum to an electronic format;
extracting data from the electronic format based on rules associated with a source of the credit memorandum;
comparing credit memorandum identification data extracted from the credit memorandum to a data set storing valid credit memorandum identifiers; and
unless the comparison indicates that the received credit memorandum is a duplicate of another previously received credit memorandum, passing the extracted data to a payment system.

7. A credit memorandum processing method comprising:
converting a paper credit memorandum to an electronic format;
extracting data from the electronic credit memorandum based on rules associated with a source of the credit memorandum;
comparing credit memorandum identification data extracted from the credit memorandum to a data set storing valid credit memorandum identifiers;
comparing transaction data extracted from the credit memorandum to a second data set of purchase order records to identify discrepancies, if any; and
unless the first comparison indicates that the received credit memorandum is a duplicate of another previously received credit memorandum or the second comparison indicates discrepancies between the transaction data extracted from the credit memorandum and the purchase order records, passing the extracted data to a payment system.

8. The credit memorandum processing method of claim 7 further comprising comparing extracted data to valid field formats to verify that the credit memorandum is valid.

9. The credit memorandum processing method of claim 7 wherein the conversion of the paper credit memorandum is done using optical character recognition technology.

10. The credit memorandum processing method of claim 7 wherein the transaction data extracted from the credit memorandum comprises a quantity of goods purchased and a description of the goods purchased.

11. A computer readable medium storing thereon program instructions that, when executed, cause an executing device to:
convert a paper invoice to an electronic format;
extract data from the electronic format based on rules associated with a source of the invoice;
compare invoice identification data extracted from the invoice to a data set storing valid invoice identifiers; and
unless the comparison indicates that the received invoice is a duplicate of another previously received invoice, pass the extracted data to a payment system.

12. A computer readable medium storing thereon program instructions that, when executed, cause an executing device to:
convert a paper invoice to an electronic format;
extract data from the electronic invoice based on rules associated with a source of the invoice;
compare invoice identification data extracted from the invoice to a data set storing valid invoice identifiers;
compare transaction data extracted from the invoice to a second data set of purchase order records to identify discrepancies, if any; and
unless the first comparison indicates that the received invoice is a duplicate of another previously received invoice or the second comparison indicates discrepancies between the transaction data extracted from the invoice and the purchase order records, pass the extracted data to a payment system.

13. The computer readable medium of claim 12 further comprising instructions that cause the executing device to compare extracted data to valid field formats to verify that the invoice is valid.

14. The computer readable medium of claim 12 wherein the conversion of the paper invoice is done using optical character recognition technology.

15. The computer readable medium of claim 12 wherein the transaction data extracted from the invoice comprises a quantity of goods purchased and a description of the goods purchased.

16. A computer readable medium storing thereon program instructions that, when executed, cause an executing device to:
convert a paper credit memorandum to an electronic format;
extract data from the electronic format based on rules associated with a source of the credit memorandum;
compare credit memorandum identification data extracted from the credit memorandum to a data set storing valid credit memorandum identifiers; and
unless the comparison indicates that the received credit memorandum is a duplicate of another previously received credit memorandum, pass the extracted data to a payment system.

17. A computer readable medium storing thereon program instructions that, when executed, cause an executing device to:
convert a paper credit memorandum to an electronic format;
extract data from the electronic credit memorandum based on rules associated with a source of the credit memorandum;
compare credit memorandum identification data extracted from the credit memorandum to a data set storing valid credit memorandum identifiers;
compare transaction data extracted from the credit memorandum to a second data set of purchase order records to identify discrepancies, if any; and
unless the first comparison indicates that the received credit memorandum is a duplicate of another previously received credit memorandum or the second comparison indicates discrepancies between the transaction data extracted from the credit memorandum and the purchase order records, pass the extracted data to a payment system.

18. The computer readable medium of claim 17 further comprising instructions that cause the executing device to compare extracted data to valid field formats to verify that the credit memorandum is valid.

19. The computer readable medium of claim 17 wherein the conversion of the paper credit memorandum is done using optical character recognition technology.

20. The computer readable medium of claim 17 wherein the transaction data extracted from the credit memorandum comprises a quantity of goods purchased and a description of the goods purchased.
